(19) United States
(12) Patent Application Publication
(10) Pub. No.: US 2019/0197075 A1
(43) Pub. Date: Jun. 27, 2019

(54) SEARCH CONTROL DEVICE AND SEARCH CONTROL METHOD

(71) Applicant: FUJITSU LIMITED, Kawasaki-shi (JP)

(72) Inventors: Hideo Kamada, Yokohama (JP); Atsushi Oguchi, Kawasaki (JP)

(73) Assignee: FUJITSU LIMITED, Kawasaki-shi (JP)

(21) Appl. No.: 16/224,395

(22) Filed: Dec. 18, 2018

(30) Foreign Application Priority Data
Dec. 22, 2017 (JP) 2017-246558

(51) Int. Cl. G06F 16/9537; G06F 16/28; G06F 16/78

(52) U.S. Cl. CPC G06F 16/9537; G06F 16/7867; G06F 16/28

(57) ABSTRACT

A search control device includes one or more processors configured to sequentially receive a plurality of pieces of divided data generated by dividing first data and store the received plurality of pieces of divided data, receive a plurality of pieces of search data to be used for obtaining the plurality of pieces of divided data, perform determination of whether one or more pieces of divided data related to each of the plurality of pieces of search data have been received, and add, when first divided data related to first search data has been received, the first search data into a search target so as to allow the first search data to be searched by a search requested from a terminal wherein second search data is not added into the search target when second divided data related to the second search data has not been received.

### CROSS-REFERENCE TO RELATED APPLICATION

This application is based upon and claims the benefit of priority of the prior Japanese Patent Application No. 2017-246558, filed on Dec. 22, 2017, the entire contents of which are incorporated herein by reference.

### FIELD

The embodiment discussed herein relates to a search control technique.

### BACKGROUND

Nowadays, regarding video viewing, time spent on viewing moving images and recorded videos on the Internet increases. The number of people viewing moving images at their convenient time increases. Along with this tendency, it is expected that the number of users of video on demand (VOD) services continues to increase. To date, in the VOD services, reproduction techniques have focused on reduction of latency for reproduction and reducing interruption of reproduction.

Furthermore, since the number of items of content to be delivered has largely increased, realization of “scene viewing”, which suits preference of users for efficient viewing of only scenes that the users wish to view in a limited time, is becoming important. In such scene viewing, it is expected that a plurality of scenes obtained from a search result are changed during viewing. However, at the time of changing the scenes, there may be latency due to loading of a video. This may degrade comfort in viewing. Accordingly, a technique has been proposed which preloads a searched scene video so as to reduce the latency for reproduction during changing of the scenes.

For example, a moving image reproduction device has been proposed in which latency until reproduction is started is able to be reduced. This device obtains from an external device moving image data that is divided into a plurality of files to reproduce. Upon obtaining information (scene information) from the external device on the moving image data that satisfies predetermined search conditions, this device identifies, based on the obtained information, a file to be reproduced first in the moving image data (leading file) and obtains the identified file from the external device. The device stores in a storage unit the information on the moving image data and the file to be reproduced first obtained from the external device.

Furthermore, a system has been proposed which performs on demand delivery of video content from a content delivery device to a content reproduction terminal through a network. In this system, before the user reproduces video content from a delivery menu, the content reproduction terminal receives from the content delivery device in advance delivery of video content to which cache control information is added and writes the received video content to an internal temporary storage device. When video content selected by the user exists in the temporary storage device, this video content is reproduced. In contrast, when the selected video content does not exist in the temporary storage device, a request for delivery of the selected video content is transmitted to the content delivery device.

For example, Japanese Laid-open Patent Publication Nos. 2017-69708 and 2011-130018 disclose related art.

### SUMMARY

According to an aspect of the embodiments, a search control device includes one or more processors configured to sequentially receive a plurality of pieces of divided data generated by dividing first data and store the received plurality of pieces of divided data, receive a plurality of pieces of search data to be used for obtaining the plurality of pieces of divided data, perform determination of whether one or more pieces of divided data related to each of the plurality of pieces of search data have been received, and add, when first divided data related to first search data has been received, the first search data into a search target so as to allow the first search data to be searched by a search requested from a terminal wherein second search data is not added into the search target when second divided data related to the second search data has not been received.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a configuration of a video delivery system.

FIG. 2 is a functional block diagram of a provision device.

FIG. 3 illustrates an example of a baseball database.

FIG. 4 illustrates divided files and a playlist.

FIG. 5 illustrates an example of a search database in a domestic base system.

FIG. 6 illustrates a flow of scene viewing.

FIG. 7 illustrates provision of data to an overseas base system.

FIG. 8 is a functional block diagram of a search control device.

FIG. 9 illustrates identification of divided files based on scene search data.

FIG. 10 illustrates an example of a search database in the overseas base system.

FIG. 11 is a block diagram schematically illustrating a configuration of a computer functioning as a provision device.

FIG. 12 is a block diagram schematically illustrating a configuration of a computer functioning as a search control device.

FIG. 13 is a flowchart illustrating an example of provision processing.

FIG. 14 is a flowchart illustrating an example of receiving processing.

FIG. 15 is a flowchart illustrating an example of updating processing.

### DESCRIPTION OF EMBODIMENTS

In global video delivery, for example, a content delivery network (CDN) is used, and content cached in edge servers (cache servers for video content) near users are used. In this way, latency in delivery (delay time in communication occurring during data transfer) is reduced. For example, a video itself (for example, the entirety of a movie) is searched and viewed in a video on demand (VOD) service. Thus, videos efficiently cached in accordance with the number of accesses are usable.

Meanwhile, in scene viewing, video files are different from one another from scene to scene, and accordingly, the number of search target video files is large. Thus, the cache hit rate for the CDN is lower than that for a normal VOD, thereby the effect of reducing latency produced by the CDN is reduced. For example, when a user at a place geographically remote from an origin server (a server that stores original video content) for delivering videos views a video, this user obtains the video from the origin server in the case where cache in the CDN is not usable. In this case, the user at a remote location takes long time before the video is played.

Accordingly, for reducing latency in viewing content at remote locations, metadata for searching a desired scene from video files may be provided in servers at bases at remote locations so as to maintain performance equal to the origin server. However, transfer of videos takes longer time than transfer of metadata. Thus, when the video and the metadata are asynchronously transferred to a server at a remote location at respective timings at which the video and the metadata are registered in the origin server, provision of the metadata is complete before that of the video. In this case, there occurs a situation in which, for the user, search is able to be performed but the video presented as a result of the search is not able to be viewed.

Metadata and videos may be synchronously transferred on a scene-by-scene basis. In this case, however, overhead of transfer processing increases. Consequently, transfer of the metadata and the video takes long time. To reduce the overhead of transfer processing, metadata and videos of a plurality of scenes may be combined into units and synchronously transferred on a unit-by-unit basis instead of a scene-by-scene basis. In this case, however, there is a time lag in start of providing viewing of a scene between an area where the origin server is located and a remote location. For example, when video content to be provided is a video of a sports game or the like, versatility of use such as looking back a scene that user wishes to see immediately after live coverage increases as the scene viewing becomes closer to real time. Thus, it is desirable that the time lag as described above be reduced.

An example of a form of the embodiment will be described in detail below with reference to the drawings.

According to the present form, a search control device according to the embodiment is applied to a video delivery system with which scenes of pitching by a pitcher in a video of a baseball game are scene viewable as search target scenes on a pitch-by-pitch basis.

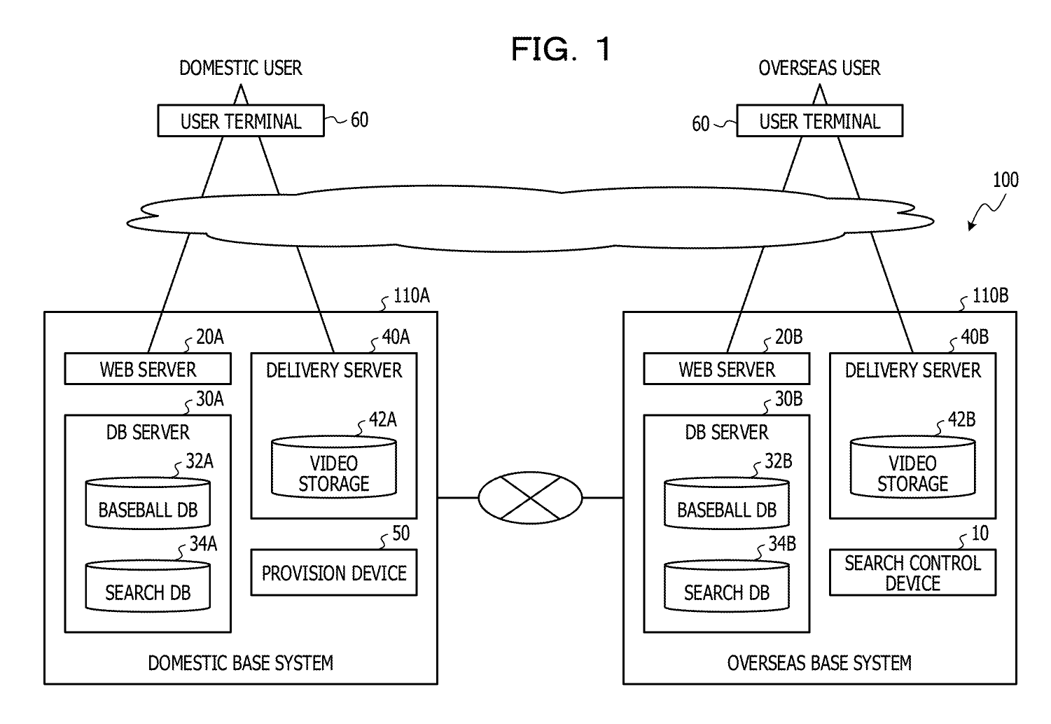

As illustrated in FIG. 1, a video delivery system 100 according to the present form includes a domestic base system 110A and an overseas base system 1106.

The domestic base system 110A is a system in which a video is registered first in the video delivery system 100. The domestic base system 110A includes a web server 20A, a database (DB) server 30A, a delivery server 40A, and a provision device 50.

The web server 20A provides a user terminal 60 used by a domestic user with an application program for video delivery. The user terminal 60 is an information processing device such as a personal computer, a smartphone, or a tablet terminal.

A various types of information required for the application program provided by the web server 20A are stored in the DB server 30A. According to the present form, a baseball DB 32A and a search DB 34A, which will be described later, are stored in the DB server 30A. The delivery server 40A includes a video storage 42A, which will be described later.

The provision device 50 provides the baseball DB 32A and the search DB 34A stored in the DB server 30A and video files stored in the video storage 42A to the overseas base system 110B. The details of the provision device 50 will be described later.

In the video delivery system 100, the overseas base system 110B is a system to which the baseball DB 32A, the search DB 34A, and the video files transferred from another base system (domestic base system 110A herein) are provided. The overseas base system 110B includes a web server 20B, a DB server 30B, a delivery server 40B, and a search control device 10.

The web server 20B provides a user terminal 60 used by an overseas user with the application program for video delivery.

The baseball DB 32A and the search DB 34A transferred from the domestic base system 110A are respectively stored as a baseball DB 32B and a search DB 34B in the DB server 30B. The delivery server 40B includes a video storage 42B in which the video files transferred from the domestic base system 110A are stored.

According to the present form, the overseas base system 110B is a system located overseas whereas the domestic base system 110A is domestically located. However, this is not limiting. It is sufficient that one of the base systems be a system in which video is registered first and the other base system be a system at a geographically remote location from the location where the one of the base systems is located.

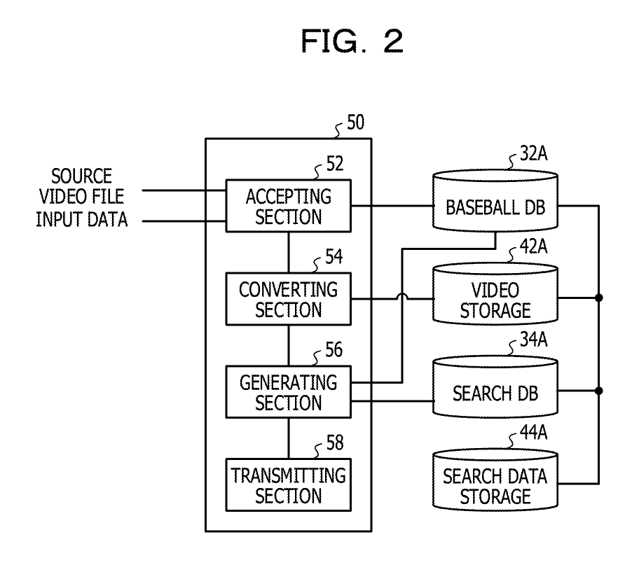

FIG. 2 is a functional block diagram of the provision device 50 included in the domestic base system 110A. As illustrated in FIG. 2, the provision device 50 includes an accepting section 52, a converting section 54, a generating section 56, and a transmitting section 58.

The accepting section 52 accepts original video files input to the domestic base system 110A and input data input by an operator as information related to the video files.

According to the present form, the original video files are data of a video of a baseball game in which each of the innings is contained in a corresponding one of the files. The original video files are, for example, video data in the moving picture experts group 4 (MP4) format. The original video file is input in real time during the baseball game every time an inning is finished.

The input data includes game information indicative of, for example, the date and time of the game and a result of the game and event information relating to pitches and ends of inning. The event information on a pitch includes event generation time indicative of the start and end of the pitch and information relating to the pitch (hereinafter referred to as “pitch information”). In the pitch information, information on a pitcher and a batter, the type of the pitch (fast ball, slider, curve, or the like) and a result of the pitch (strike, ball, hit, or the like), and so forth are encoded. The event information on the end of inning includes event generation time at which an inning ends and information indicative of an inning after the end of inning. Out of the input data, the game information is input by the operator at appropriate timing such as before, during, or after the game. The event information is input in real time during the game by, for example, the operator. The event generation time may be time tagged by the operator.

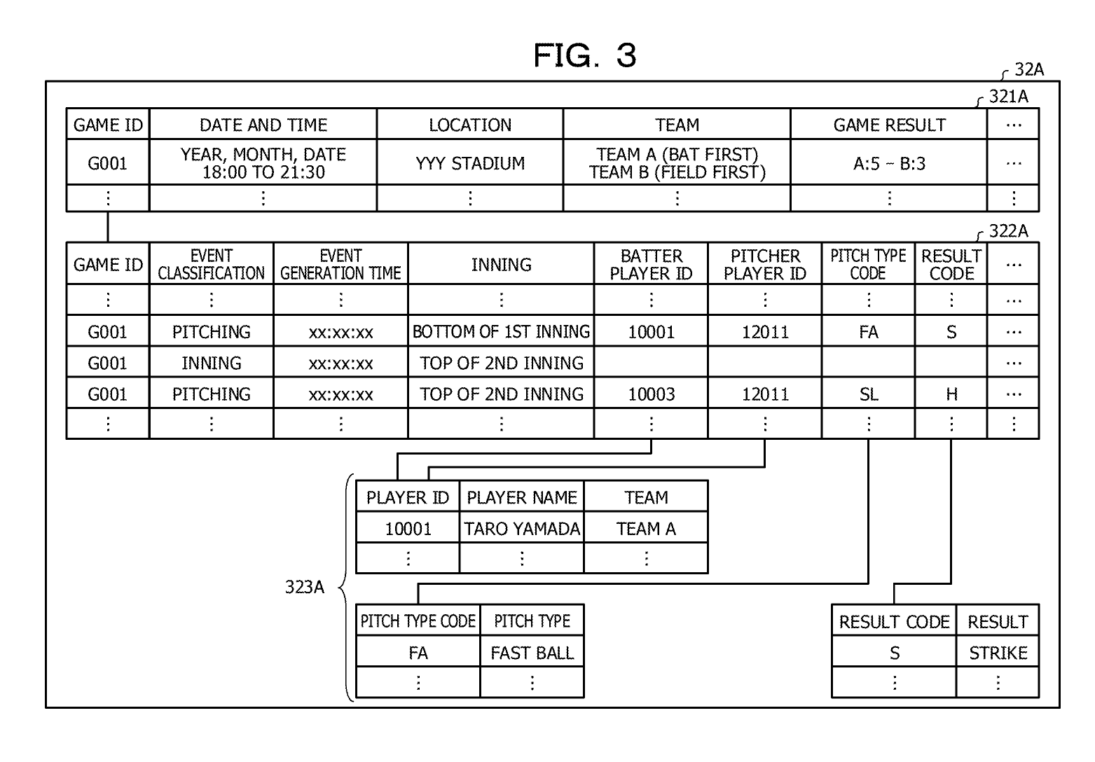

The accepting section 52 stores accepted input data in the baseball DB 32A. FIG. 3 illustrates an example of the baseball DB 32A. In the example illustrated in FIG. 3, the baseball DB 32A includes a game information table 321A in which the game information is stored and an event information table 322A in which the event information is stored. The baseball DB 32A also includes various master tables 323A in which master information such as players, teams, and various codes used for the pitch information is stored.

For example, the accepting section 52 assigns a game identification (ID) for identification of the game to the game information included in the accepted input data to store the game information in the game information table 321A. The accepting section 52 correlates the event information included in the accepted input data with the game ID to store the event information in the event information table 322A together with an event classification (“PITCH” or “(end of) INNING”). The accepting section 52 assigns information on inning indicated by the event information of the end of the inning also to the event information on pitches included in this inning. Furthermore, for example, when information relating to transfer or the like of a player is included in the input data, the accepting section 52 updates a corresponding master table 323A based on this information.

The accepting section 52 passes the accepted original video file to the converting section 54.

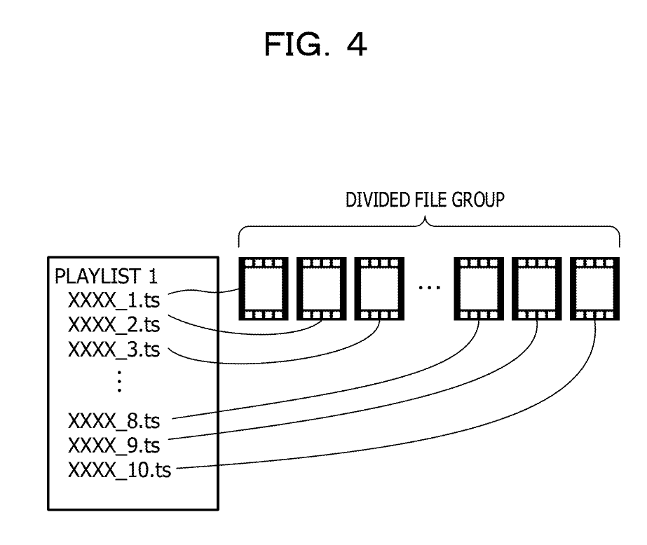

As illustrated in FIG. 4, the converting section 54 divides the original video file passed from the accepting section 52 by performing a cutting of the original video file at predetermined time periods (for example, intervals of 10 sec) to convert the original video file into a divided file group of a plurality of divided files and creates a playlist in which file paths of the divided files are described in the order of reproduction. In the conversion into the divided file group and the creation of the playlist, for example, an HTTP live streaming (HLS) may be employed. The converting section 54 stores the divided file group and the playlist in the video storage 42A. The converting section 54 passes information on a storage destination of the playlist to the generating section 56.

Based on the event information table 322A stored in the baseball DB 32A and the playlist passed from the converting section 54, the generating section 56 generates scene search data to be used for searching a scene matching to search conditions specified by the user.

For example, from the difference between event generation time of the end of inning and event generation time of the event information of a pitch, the generating section 56 identifies in the original video file a start position and an end position of a scene indicated by the event information of the pitch. The generating section 56 assigns an identifier to data in which the start position and the end position of the identified scene are correlated with the pitch information for pieces of the event information on pitches in each inning on a piece of the event information-by-piece of the event information basis. Furthermore, the generating section 56 correlates the path of the storage destination of the playlist of the divided file group of the inning in question in the video storage 42A with the above-described data to generate the scene search data.

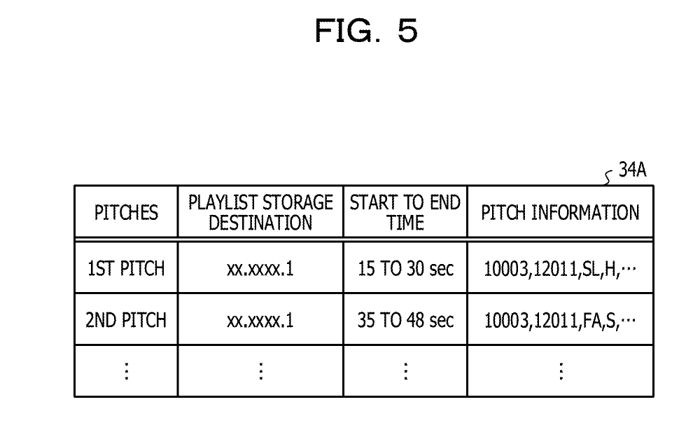

The generating section 56 stores the generated scene search data in the search DB 34A, for example, as illustrated in FIG. 5. In the example illustrated in FIG. 5, as the identifiers of pieces of the scene search data, the pitches (first pitch, second pitch, and so forth) in the inning in question are assigned in the order of “EVENT GENERATION TIME” included in each piece of the scene search data. The start position and the end position of the scene are respectively a reproduction start time and a reproduction end time (start to end time) of the scene with reference to the top of the original video file.

Scene viewing of the inning for which the divided file group, the playlist, the baseball DB 32A, and the search DB 34A are provided to the domestic base system 110A is allowed for the user through the application program.

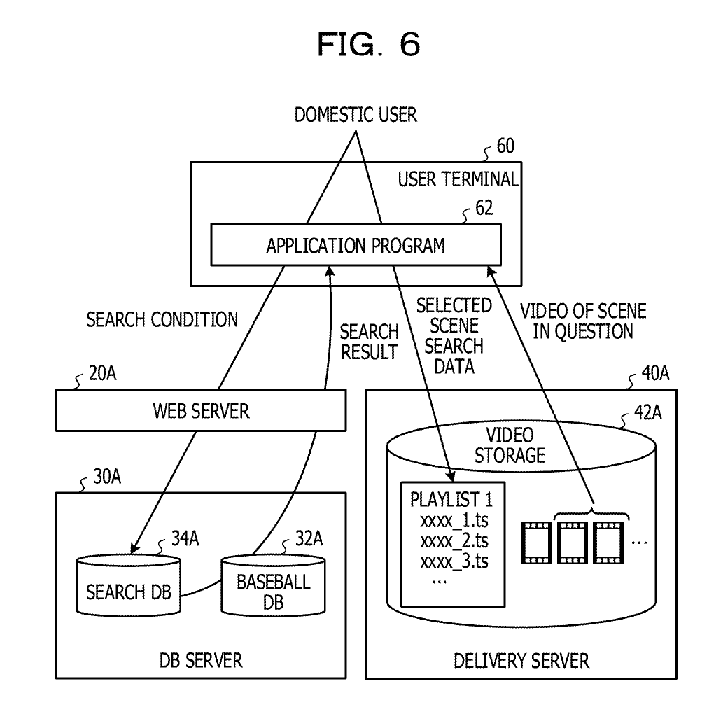

Here, the flow of the scene viewing is described with reference to FIG. 6. First, the user starts up on the user terminal 60 an application program 62 provided by the video delivery system 100 and inputs search conditions. For example, the user is able to input the search conditions by choosing a name of a player, a result of a pitch, a type of a pitch, and the like from, for example, a pull-down menus. The search conditions having been input are encoded by the application program 62 and transmitted to the web server 20A. The web server 20A searches from the search DB 34A scene search data in which “PITCH INFORMATION” matches to the received search conditions. The web server 20A adds game information corresponding to the searched scene search data by referring to the baseball DB 32A and converts the encoded information in the scene search data into character strings to return search results to the application program 62.

The application program 62 displays the search results and accepts selection by the user from the search results corresponding the scene to be viewed in scene viewing. Based on the “PLAYLIST STORAGE DESTINATION” included in the scene search data corresponding to the accepted scene, the application program 62 refers to the playlist stored in the video storage 42A. The application program 62 obtains from the video storage 42A divided files corresponding to the “START TO END TIME” in the scene search data to reproduce the scene in question.

The transmitting section 58 transmits data so that the baseball DB 32B, the video storage 42B, and the search DB 34B respectively similar to the baseball DB 32A, the video storage 42A, and the search DB 34A are provided to the overseas base system 110B.

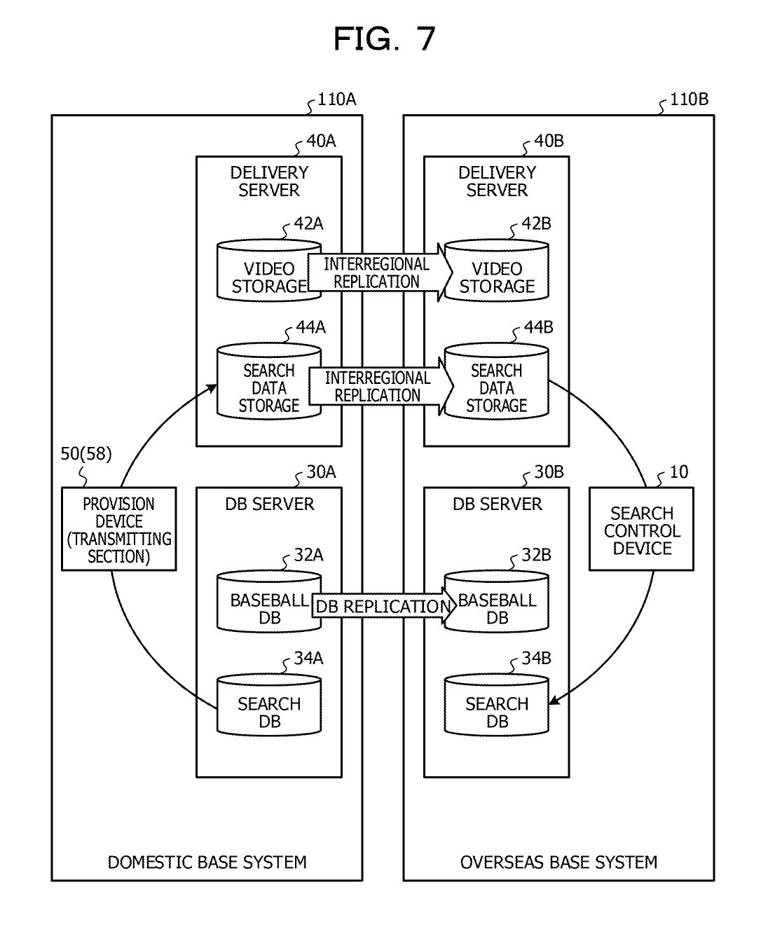

Here, an object of the present form is to reduce latency between the domestic base system 110A and the overseas base system 110B and provide the overseas base system 110B with a search environment equal to that of the domestic base system 110A as quickly as possible. Accordingly, as illustrated in FIG. 7, the transmitting section 58 is set so as to provide data to the overseas base system 110B.

For example, it is preferable that the baseball DB 32B, which is used for a search screen or the like provided by the application program, be able to be referred to by the overseas base system 110B without waiting for provision of the video files. For this, the transmitting section 58 sets DB replication between the baseball DB 32A and the baseball DB 32B. Thus, as soon as the data is stored in the baseball DB 32A of the domestic base system 110A, duplication and provision of the data to the baseball DB 32B of the overseas base system 110B are started.

Furthermore, for the video storage 42B to which a large amount of data is duplicated and provided, it is preferable that fast data transfer be performed between the servers geographically separated from each other by a long distance. For this, the transmitting section 58 sets interregional replication of a cloud service between the video storage 42A and the video storage 42B. Thus, soon after the divided files and the playlist have been stored in the video storage 42A of the domestic base system 110A, duplication and provision of the divided files and the playlist to the video storage 42B of the overseas base system 110B are started.

Although the details will be described later, the search control device 10 assigns a “SEARCH TARGET FLAG”, which is not assigned to the search DB 34A, to the search DB 34B. Accordingly, direct use of a DB replication function, which is able to be performed on the baseball DB 32A (32B), is not able to be performed on the search DB 34B. Accordingly, the transmitting section 58 writes the scene search data stored in the search DB 34A to a file and stores this file in a search data storage 44A once. The transmitting section 58 sets the interregional replication between the search data storage 44A of the domestic base system 110A and a search data storage 44B of the overseas base system 110B. This allows the scene search data to be quickly duplicated and provided without newly preparing a special transfer method.

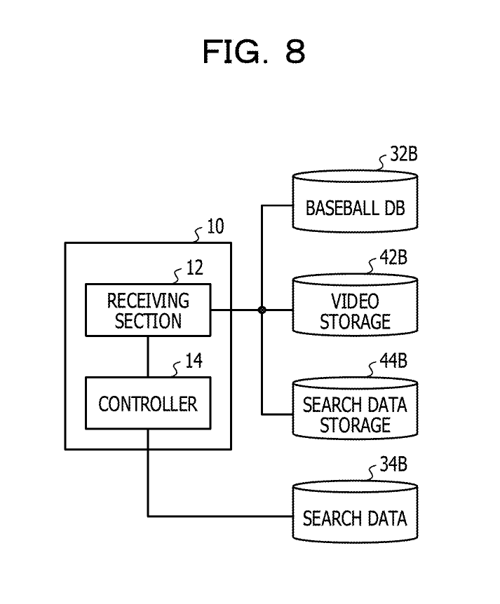

FIG. 8 is a functional block diagram of the search control device 10 included in the overseas base system 110B. The search control device 10 includes a receiving section 12 and a controller 14.

The receiving section 12 sets the DB replication between the baseball DB 32B and the baseball DB 32A. The receiving section 12 sets the interregional replication of the cloud service between the video storage 42B and the video storage 42A and between the search data storage 44B and the search data storage 44A. Thus, the receiving section 12 receives the data transferred from the domestic base system 110A to the overseas base system 110B.

Upon detection of an update event indicative of new storing of the file in the search data storage 44B, the receiving section 12 reads the newly stored file to pass this file to the controller 14.

For each piece of the scene search data included in the file passed from the receiving section 12, the controller 14 identifies the divided files corresponding to the piece of scene search data. The controller 14 controls whether to regard a scene corresponding to the piece of the scene search data as a search target in accordance with whether the divided files in question have arrived, for example, whether the divided files in question are stored in the video storage 42B.

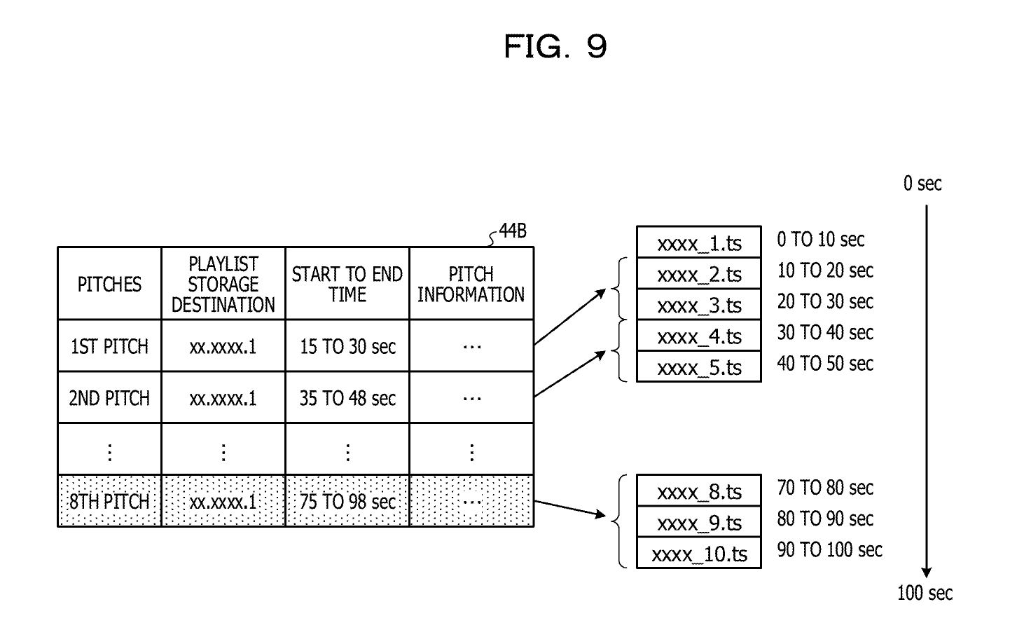

For example, as illustrated in FIG. 9, the controller 14 refers to the playlist in question stored in the video storage 42B based on the “PLAYLIST STORAGE DESTINATION” for the piece of the scene search data newly stored in the search data storage 44B. Based on the “START TO END TIME” of the piece of the scene search data and information on the number of seconds of the intervals of the divided file group, the controller 14 identifies in the playlist the divided files including the scene indicated by the piece of the scene search data.

For example, in the example illustrated in FIG. 9, the “START TO END TIME” of the piece of the scene search data of a “1ST PITCH” is from 15 to 30 sec, and the divided files are formed by being cut once every 10 sec. Accordingly, the controller 14 identifies that the scene indicated by the piece of the scene search data of the “1ST PITCH” is included in the divided files “XXXX_2.ts” and “XXXX_3.ts”.

The controller 14 determines whether the identified divided files have arrived, for example, whether the identified divided files are stored in the video storage 42B. When identified divided files have arrived, the controller 14 sets in the piece of the scene search data in question a search target flag indicating that this piece of the scene search data is the search target. In contrast, when the identified divided files have not arrived, the controller 14 sets in the piece of the scene search data in question a search target flag indicating that this piece of the scene search data is not the search target.

For example, in the example illustrated in FIG. 9, it is assumed that the divided files corresponding to the piece of the scene search data of an “8TH PITCH” are identified to be “XXXX_8.ts”, “XXXX_9.ts” and “XXXX_10.ts”, and the divided file “XXXX_10.ts” has not arrived. In this case, the controller 14 sets in the piece of the scene search data of the “8TH PITCH” the search target flag indicating that this piece of the scene search data is not the search target.

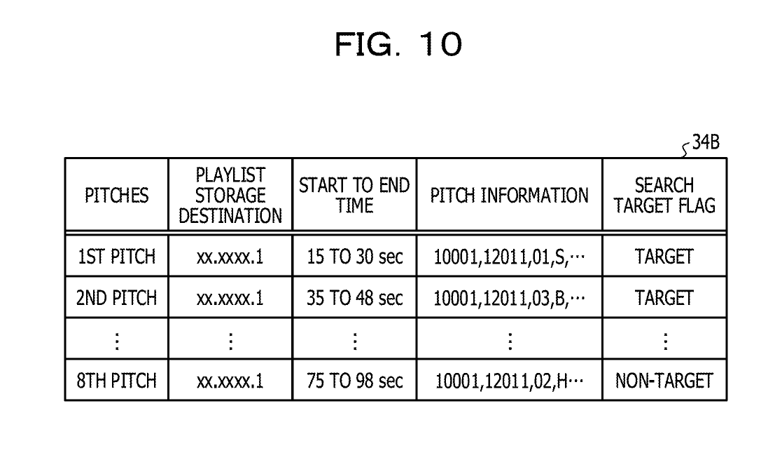

The controller 14 stores in the search DB 34B the pieces of the scene search data in which the search target flags have been set as illustrated in FIG. 10. In the example illustrated in FIG. 10, the search target flags indicative of the search target are represented as “TARGET”, and the search target flags indicative of the non-search target are represented as “NON-TARGET”.

The pieces of the scene search data the search target flag of which is “NON-TARGET” are excluded from search target when searching the pieces of the scene search data matching to the search conditions accepted from the user. For example, the pieces of the scene search data matching to the search conditions are searched from the pieces of the scene search data the search target flag of which is “TARGET” out of the pieces of the scene search data stored in the search DB 34B.

There may be a case where the duplication and provision of the scene search data having a smaller file size than that of the video files have been completed earlier and the scene search data exists in the overseas base system 1106 while the corresponding divided files do not exist. In this case, there occurs an inconvenience in that, even when the search result matching to the search conditions is presented, the video of the scene indicated by the search result is not able to be viewed even by selecting the search result. Such an inconvenience may be suppressed by excluding from the search target the pieces of the scene search data for which the corresponding divided files do not exist as described above.

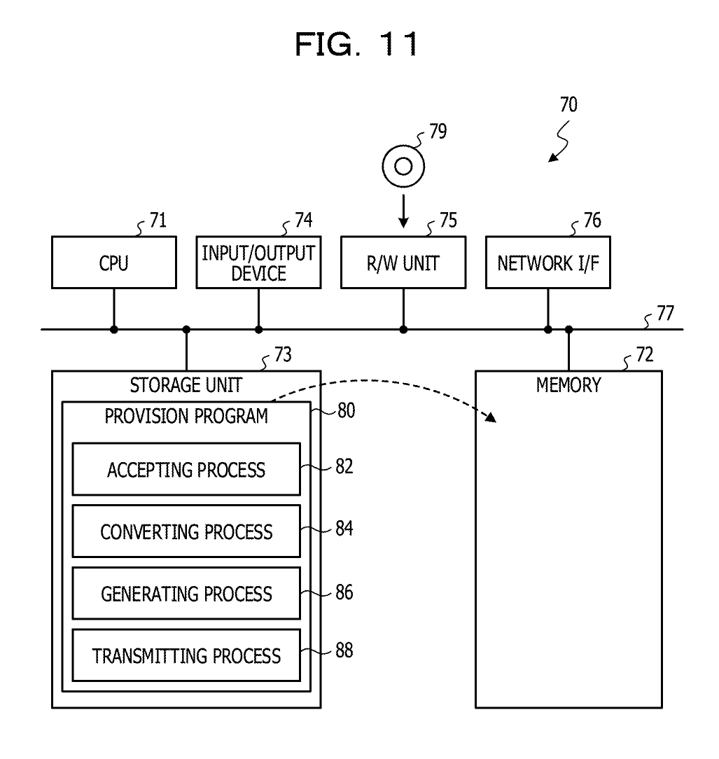

The provision device 50 is able to be realized by, for example, a computer 70 illustrated in FIG. 11. The computer 70 includes a central processing unit (CPU) 71, a memory 72 as a temporary storage area, and a nonvolatile storage unit 73. The computer 70 also includes an input/output device 74, a read/write (R/W) unit 75, and a communication interface (I/F) 76. The input/output device 74 includes an input device, a display, and so forth. The R/W unit 75 controls reading of data from a storage medium 79 and writing of data to the storage medium 79. The communication I/F 76 is connected to a network such as the Internet. The CPU 71, the memory 72, the storage unit 73, the input/output device 74, the R/W unit 75, and the communication I/F 76 are connected to one another through a bus 77.

The storage unit 73 is able to be realized by a hard disk drive (HDD), a solid-state drive (SSD), flash memory, or the like. The storage unit 73 as a storage medium stores a provision program 80 that causes the computer 70 to function as the provision device 50. The provision program 80 includes a plurality of instructions for an accepting process 82, a converting process 84, a generating process 86, and a transmitting process 88.

The CPU 71 reads the provision program 80 from the storage unit 73 and loads the provision program 80 in the memory 72 so as to sequentially execute the processes included in the provision program 80. The CPU 71 operates as the accepting section 52 illustrated in FIG. 2 when the accepting process 82 is executed. The CPU 71 also operates as the converting section 54 illustrated in FIG. 2 when the converting process 84 is executed. The CPU 71 also operates as the generating section 56 illustrated in FIG. 2 when the generating process 86 is executed. The CPU 71 also operates as the transmitting section 58 illustrated in FIG. 2 when the transmitting process 88 is executed. In this way, the computer 70 executing the provision program 80 functions as the provision device 50. The CPU 71 that executes the program is hardware.

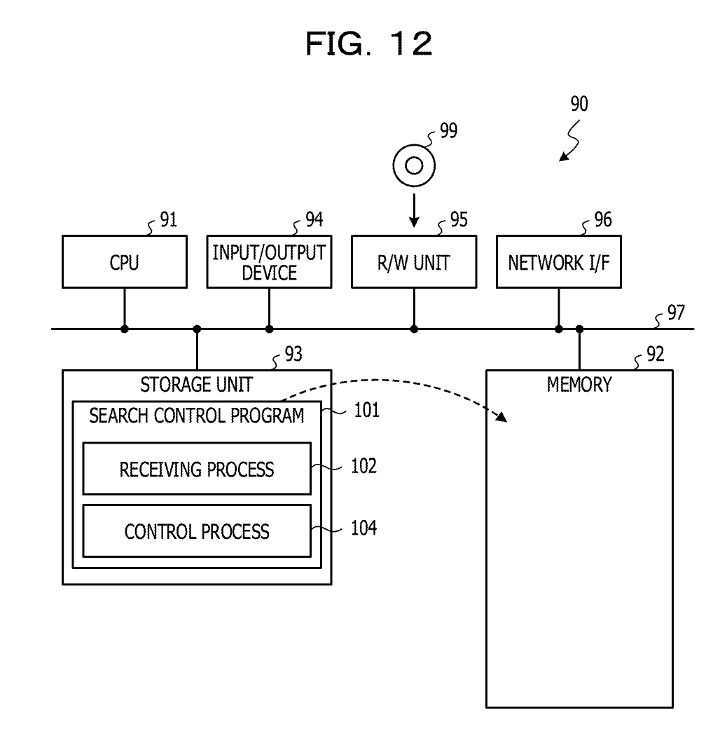

The search control device 10 is able to be realized by, for example, a computer 90 illustrated in FIG. 12. The computer 90 includes a CPU 91, a memory 92 as a temporary storage area, and a nonvolatile storage unit 93. The computer 90 also includes an input/output device 94, a R/W unit 95, and a communication I/F 96. The input/output device 94 includes an input device, a display, and so forth. The R/W unit 95 controls reading of data from a storage medium 99 and writing of data to the storage medium 99. The CPU 91, the memory 92, the storage unit 93, the input/output device 94, the R/W unit 95, and the communication I/F 96 are connected to one another through a bus 97.

The storage unit 93 is able to be realized by an HDD, an SSD, a flash memory, or the like. The storage unit 93 as a storage medium stores a search control program 101 that causes the computer 90 to function as the search control device 10. The search control program 101 includes a plurality of instructions for a receiving process 102 and a control process 104.

The CPU 91 reads the search control program 101 from the storage unit 93 and loads the search control program 101 in the memory 92 so as to sequentially execute the processes included in the search control program 101. The CPU 91 operates as the receiving section 12 illustrated in FIG. 8 when the receiving process 102 is executed. The CPU 91 also operates as the controller 14 illustrated in FIG. 8 when the control process 104 is executed. In this way, the computer 90 executing the search control program 101 functions as the search control device 10. The CPU 91 that executes the program is hardware.

The functions realized by each of the provision program 80 and the search control program 101 are also able to be realized by, for example, a semiconductor integrated circuit, for example, an application specific integrated circuit (ASIC) or the like.

Next, operation of the video delivery system 100 according to the present form is described.

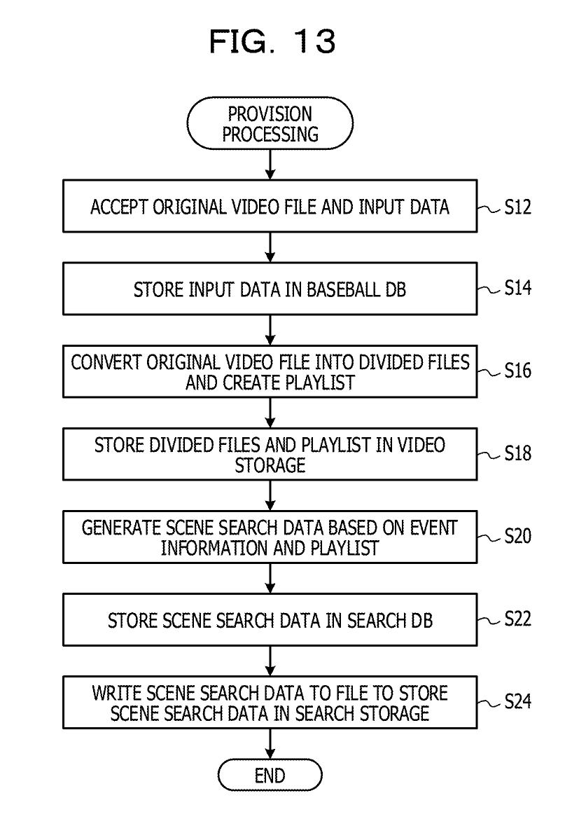

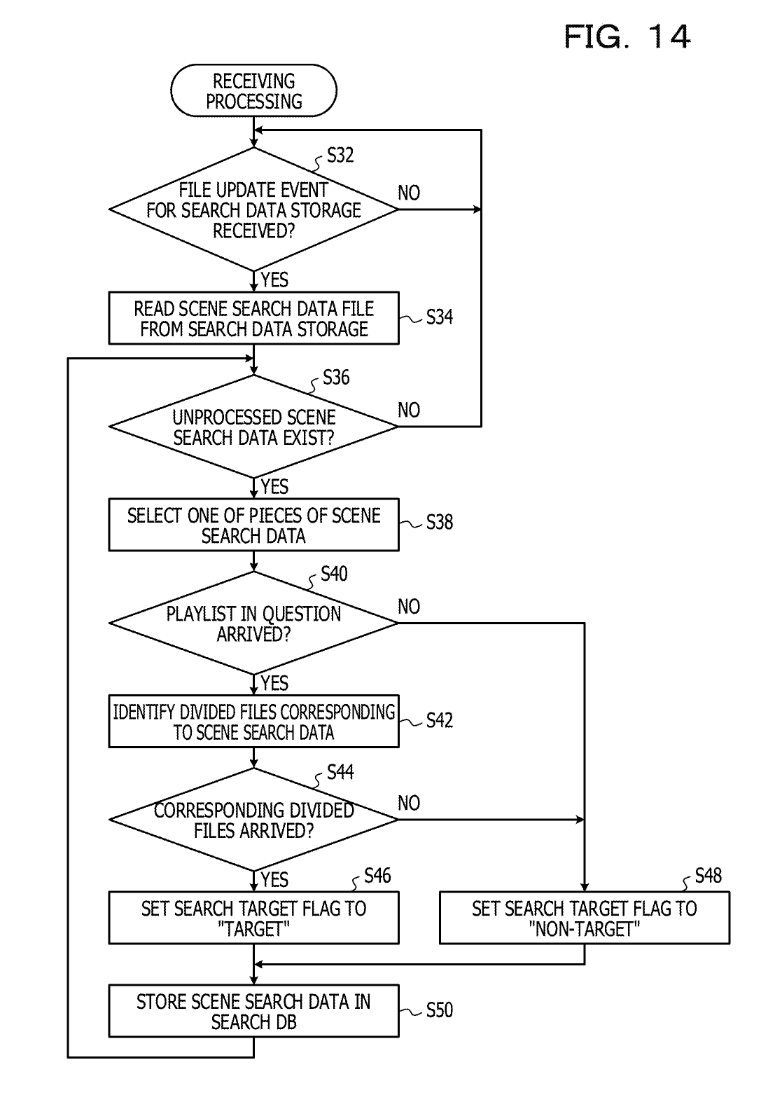

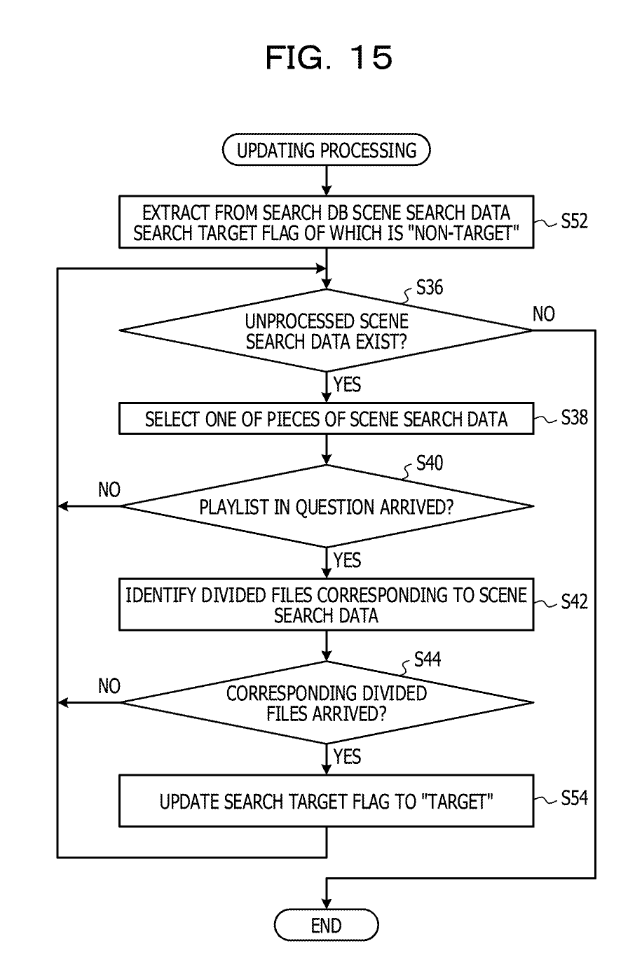

When the original video file and the input data are input to the domestic base system 110A, provision processing illustrated in FIG. 13 is performed by the provision device 50. Furthermore, the transmitting section 58 of the provision device 50 sets the replication of the baseball DBs 32A and 32B, the video storages 42A and 42B, and the search data storages 44A and 44B. The search control device 10 of the overseas base system 110B performs receiving processing illustrated in FIG. 14 and updating processing illustrated in FIG. 15. Hereinafter, the details of the provision processing, the receiving processing, and the updating processing will be described. The receiving processing and the updating processing exemplify a method of controlling a search according to the embodiment.

First, the provision processing illustrated in FIG. 13 is described.

In step S12, the accepting section 52 accepts the original video file and the input data input to the domestic base system 110A.

Next, in step S14, the accepting section 52 assigns the game ID for identification of the game to the game information included in the accepted input data to store the game information in the game information table 321A of the baseball DB 32A. The accepting section 52 correlates the event information included in the accepted input data with the game ID to store the event information in the event information table 322A of the baseball DB 32A together with the event classification (“PITCH” or “(end of) INNING”). The accepting section 52 assigns information on the inning indicated by the event information of the end of the inning also to the event information on pitches included in this inning. Furthermore, for example, when information relating to transfer or the like of a player is included in the input data, the accepting section 52 updates a corresponding master table 323A based on this information.

Next, in step S16, the accepting section 52 passes the accepted original video file to the converting section 54. As illustrated in FIG. 4, the converting section 54 divides the original video file passed from the accepting section 52 by performing a cutting of the original video file at predetermined time periods (for example, intervals of 10 sec) to convert the original video file into the divided file group of a plurality of divided files and creates the playlist in which file paths of the divided files are described in the order of reproduction.

Next, in step S18, the converting section 54 stores the divided file group and the playlist in the video storage 42A. The converting section 54 passes the information on the storage destination of the playlist to the generating section 56.

Next, in step S20, the generating section 56 identifies the start position and the end position of each of the scenes indicated in the event information of the pitches in accordance with the event information table 322A stored in the baseball DB 32A. The generating section 56 assigns the identifier to the data in which the start position and the end position of the identified scene are correlated with the pitch information for the pieces of the event information on pitches in each inning on a piece of the event information-by-piece of the event information basis. Furthermore, the generating section 56 correlates the path of the storage destination of the playlist of the divided file group of the inning in question in the video storage 42A with the above-described data to generate the scene search data.

Next, in step S22, the generating section 56 stores the generated scene search data in the search DB 34A, for example, as illustrated in FIG. 5.

Next, in step S24, the transmitting section 58 writes the scene search data stored in the search DB 34A to a file and stores this file in a search data storage 44A once. Thus, the provision processing ends. The provision processing is repeatedly performed every time the original video file and the input data are input.

The transmitting section 58 has set the replication of the baseball DBs 32A and 32B, the video storages 42A and 42B, and the search data storages 44A and 44B. Thus, duplication and provision of the data stored in the domestic base system 110A to the overseas base system 110B are started.

Next, the receiving processing illustrated in FIG. 14 is described.

In step S32, whether the receiving section 12 has detected the update event indicative of new storing of the file in the search data storage 44B is determined. When the receiving section 12 has detected the update event, the processing proceeds to step S34. When the receiving section 12 has not detected the update event, the determination of this step is repeated.

In step S34, the receiving section 12 reads the file of the newly stored scene search data from the search data storage 44B to pass the file to the controller 14.

Next, in step S36, the controller 14 determines whether the file of the scene search data passed from the receiving section 12 includes pieces of the scene search data for which subsequent processing has not been performed. When the unprocessed pieces of the scene search data exist, the processing proceeds to step S38. When all the pieces of the scene search data included in the file have been processed, the processing returns to step S32.

In step S38, the controller 14 selects one of unprocessed pieces of the scene search data from the file.

Next, in step S40, based on the “PLAYLIST STORAGE DESTINATION” for the selected piece of the scene search data, the controller 14 determines whether the playlist in question is stored in the video storage 42B, thereby whether the playlist has arrived is determined. When the playlist has arrived, the processing proceeds to step S42. When the playlist has not arrived, the processing proceeds to step S48.

In step S42, the controller 14 obtains the “START TO END TIME” of the piece of the scene search data selected in step S38 described above and the information on the number of seconds of the intervals of the divided file group. Based on the obtained information, the controller 14 identifies in the playlist in question the divided files including the scene indicated by the piece of the scene search data.

Next, in step S44, the controller 14 determines whether the divided files identified in step S42 described above are stored in the video storage 42B, thereby whether the divided files corresponding to the piece of the scene search data have arrived is determined. When the divided files have arrived, the processing proceeds to step S46. When the divided files have not arrived, the processing proceeds to step S48.

In step S46, the controller 14 sets the “TARGET” search target flag in the piece of the scene search data selected in step S38 described above. In contrast, in step S48, the controller 14 sets the “NON-TARGET” search target flag in the piece of the scene search data selected in step S38 described above.

Next, in step S50, the controller 14 stores in the search DB 34B the piece of the scene search data in which the search target flag has been set, and the processing returns to step S36.

Next, the updating processing illustrated in FIG. 15 is described. The updating processing is repeatedly performed at regular timings.

In step S52, the controller 14 extracts from the search DB 34B pieces of the scene search data the search target flag of which is “NON-TARGET”.

Next, in step S36, the controller 14 determines whether the pieces of the scene search data having been extracted in step S52 include pieces of the scene search data for which the subsequent processing has not been performed. When the unprocessed pieces of the scene search data exist, the processing proceeds to step S38, and, as is the case with the above-described receiving processing illustrated in FIG. 14, whether the divided files corresponding to the piece of the scene search data have arrived in steps S38 to S44.

When the divided files in question have arrived, the processing proceeds to step S54, the controller 14 updates the search target flag of the piece of the scene search data having been selected in step S38 described above to “TARGET”, and the processing returns to step S36.

When it is determined in step S36 that all the pieces of the scene search data extracted in step S52 described above have been processed, the updating processing ends.

As has been described, with the video delivery system according to the present form, the divided files of the video and the scene search data for each of scenes included in the video for searching the scenes are asynchronously duplicated and provided to the overseas base system from the domestic base system being the remote location. In this case, the search control device of the overseas base system controls so that, when the divided files including the scene indicated by the scene search data have not arrived at the overseas base system, this scene search data is not included in the search target. In this way, an inconvenience in that the video of the scene is not able to be reproduced despite being presented in the search result may be suppressed. This may provide the search environment to the domestic base system and the search environment to the overseas base system which are equal to each other.

The DBs and the storages are transferred as the data for duplication between the domestic base system and the overseas base system by, for example, the replication function. This may reduce latency between the domestic base system and the overseas base system. In so doing, without newly preparing a special transfer method, the embodiment is applicable to search DB, in which the scene search data is stored, by writing to the file, storing this file in the search data storage once, and performing the replication between the search data storages.

In the above-described form, as the scene search data, data in which the pitching information is encoded is used. However, this is not limiting. Information on players, types of pitch, results of pitch, and so forth may be included as character strings. However, when various types of information of the scene search data are encoded as in the above-described form, the scene search data may have a data structure suitable for searching unlike information of the baseball DB used in a display screen that is an interface of the application program.

According to the above-described form, the search target flags are set to be “TARGET” or “NON-TARGET” in the receiving processing, and then the pieces of the scene search data are stored in the search DB. However, this is not limiting. For example, the search target flags of all the pieces the scene search data having newly arrived at the overseas base system may be set to “NON-TARGET” once and stored in the search DB. In this case, it is sufficient that the search target flags be updated to “TARGET” by the updating processing sequentially from the piece of the scene search data for which the corresponding divided files arrive.

According to the above-described form, the video of the baseball game is contained in the video files each containing a corresponding one of the innings, and the scene of each pitch is able to be searched as the target of scene viewing. However, this is not limiting. An appropriate setting in which, for example, a single video file includes a single game or scene viewing is available on a plate appearance-by-plate appearance basis is possible. The target video is not limited to a video of a baseball game. The technique herein is applicable to any of various videos including videos of other sports and so forth.

According to the above-described form, a first data of the embodiment is a video file and a second data of the embodiment is scene search data. However, this is not limiting. For example, the first data may be a music data. The embodiment is suitable for the case where the second data is smaller than the first data in size and the first data and the second data are provided in an asynchronous manner to locations remote from each other.

According to the above-described form, the provision program 80 and the search control program 101 are installed in advance in the storage units 73 and 93. However, this is not limiting. The programs according to the disclosed technique is able to be provided in a form in which the programs are stored in a storage medium such as a compact disk (CD) read-only memory (ROM), a digital versatile disk (DVD) ROM, a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A search control device comprising:
one or more memories; and
one or more processors coupled to the one or more memories and the one or more processors configured to
sequentially receive a plurality of pieces of divided data generated by dividing first data and store the received plurality of pieces of divided data in the one or more memories,
receive a plurality of pieces of search data to be used for obtaining the plurality of pieces of divided data,
by referring to the one or more memories, perform determination of whether, from among the plurality of pieces of divided data, one or more pieces of divided data related to each of the plurality of pieces of search data have been received, and
add, when first divided data related to first search data has been received, the first search data into a search target so as to allow the first search data to be searched by a search requested from a terminal wherein second search data is not added into the search target when second divided data related to the second search data has not been received.

2. The search control device according to claim 1, wherein
the one or more processors are configured to
select, when the first search data is specified by the search, in accordance with the first search data, the first divided data related to the first search data from among the plurality of pieces of divided data, and
transmit the selected second divided data to the terminal.

3. The search control device according to claim 1, wherein
the plurality of pieces of divided data and the plurality of pieces of search data are transmitted by replication processing from another search control device.

4. The search control device according to claim 1,
wherein the one or more processors are configured to receive order information indicating order of the plurality of pieces of divided data, and
wherein the determination is executed in accordance with the sequence information.

5. The search control device according to claim 1, wherein
the first search data includes positional information in the first data.

6. The search control device according to claim 1, wherein
the one or more processors are configured to add the second search data into the search target in response to receiving the first divided data.

7. The search control device according to claim 1, wherein
the first data is video data, and each of the plurality of pieces of search data identifies respective scenes in the video data.

8. The search control device according to claim 4, wherein
the first data is video data, and the order information indicates the order of the plurality of pieces of divided data in the video data.

9. A computer-implemented search control method comprising:
sequentially receiving a plurality of pieces of divided data generated by dividing first data and store the received plurality of pieces of divided data in the one or more memories;
receiving a plurality of pieces of search data to be used for obtaining the plurality of pieces of divided data;
by referring to the one or more memories, determining whether, from among the plurality of pieces of divided data, one or more pieces of divided data related to each of the plurality of pieces of search data have been received; and
adding, when first divided data related to first search data has been received, the first search data into a search target so as to allow the first search data to be searched by a search requested from a terminal wherein second search data is not added into the search target when second divided data related to the second search data has not been received.

10. The search control method according to claim 9, further comprising:
selecting, when the first search data is specified by the search, in accordance with the first search data, the first divided data related to the first search data from among the plurality of pieces of divided data; and
transmitting the selected second divided data to the terminal.

11. The search control method according to claim 9, wherein
the plurality of pieces of divided data and the plurality of pieces of search data are transmitted by replication processing from another search control device.

12. The search control method according to claim 9, further comprising:
receiving order information indicating order of the plurality of pieces of divided data, wherein the determination is executed in accordance with the sequence information.

13. The search control method according to claim 9, wherein
the first search data includes positional information in the first data.

14. The search control method according to claim 9, further comprising:
adding the second search data into the search target in response to receiving the first divided data.

15. The search control method according to claim 9, wherein
the first data is video data, and each of the plurality of pieces of search data identifies respective scenes in the video data.

16. The search control method according to claim 12, wherein
the first data is video data, and the order information indicates the order of the plurality of pieces of divided data in the video data.

17. A non-transitory computer-readable medium storing instructions executable by one or more computers, the instructions comprising:
one or more instructions for sequentially receiving a plurality of pieces of divided data generated by dividing first data and store the received plurality of pieces of divided data in the one or more memories;
one or more instructions for receiving a plurality of pieces of search data to be used for obtaining the plurality of pieces of divided data;
one or more instructions for determining, by referring to the one or more memories, whether, from among the plurality of pieces of divided data, one or more pieces of divided data related to each of the plurality of pieces of search data have been received; and
one or more instructions for adding, when first divided data related to first search data has been received, the first search data into a search target so as to allow the first search data to be searched by a search requested from a terminal wherein second search data is not added into the search target when second divided data related to the second search data has not been received.
